(19) United States
(12) Patent Application Publication
(10) Pub. No.: US 2012/0275477 A1
(43) Pub. Date: Nov. 1, 2012

(54) SUPPRESSION OF COHERENCE EFFECTS IN FIBER LASERS

(76) Inventors: Martin Ole Berendt, Arvore (PT); Dionisio Cerqueira Alves Pereira, Avintes (PT)

(21) Appl. No.: 13/096,958

(22) Filed: Apr. 28, 2011

(51) Int. Cl. H01S 3/098; H01S 3/10

(52) U.S. Cl. 372/18; 372/26

(57) ABSTRACT

The present invention provides, in at least one embodiment, a scheme which is effective in suppressing detrimental coherence effects such as random backscatter. In a fiber laser having a master oscillator power amplifier design, inserting a decorrelator in between the master oscillator and a first power amplifier or inserting a decorrelator in between the first power amplifier and a second power amplifier to reduce random backscatter, which allows for much more energy to be stored and higher gain without the risk of catastrophic optical damage, thus increasing the peak power that can be delivered as useful laser power. Backscattering can be further reduced by having the master oscillator depolarized, injection locked, and spectrally broadened to reduce the coherence length of the master oscillator.

### BACKGROUND OF THE INVENTION

1. Field of Invention

The invention relates generally to lasers, and more particularly, to techniques for suppressing detrimental coherence effects in high power fiber lasers.

2. Description of Related Art

Power scaling of a laser increases the laser's output power without changing the laser's principle of operation or output characteristics. Power scaling typically requires a powerful pump source and strong amplification associated with high laser medium gain levels. A popular way of achieving power scaling is through implementation of a master oscillator power amplifier (MOPA) design.

FIG. 1 illustrates a conventional master oscillator power amplifier design 100 having a master oscillator 105 and a power amplifier 115. The master oscillator 105 produces a laser signal, and the power amplifier 115 is used to increase the power of the signal while preserving its main properties. The master oscillator 105 does not have to be very powerful or operate at high efficiency because the efficiency is determined mainly by the power amplifier 115. For the purposes of this patent application, a master oscillator power amplifier may include a master oscillator fiber amplifier.

The master oscillator 105 is often a solid state laser. Solid state lasers include semiconductor laser diodes, disk lasers, fiber lasers, and fiber disk lasers. Disk lasers are designed for good power scaling, but power scaling is limited by concepts referred to as amplified spontaneous emission (ASE), overheating, and round-trip loss. Fiber lasers are also known for good power scaling, but power scaling is limited by effects such as Raman scattering, Brillouin and coherence scattering, and laser length. The limit of power scaling of fiber lasers can be extended with lateral delivery of the pump, which is realized in fiber disk lasers. The pump in a fiber disk laser is delivered from the side of a disk, made of coiled gain fiber with a doped core. Coherence effects such as random backscattering are particularly troublesome in a cost effective master oscillator power amplifier design, which often uses optical components and a low power oscillator, such that pulses in the backward direction diminish the intended performance of the design.

Random backscattering is considered random because a backward pulse may happen for one out of many forward pulses. Random backscatter is not well understood, but has been observed independently in many systems, and is related to coherence length (e.g., linewidth) of the master oscillator, backreflections, and amplifier gain (which is related to power).

Random backscattering occurs in the amplifier stages of the master oscillator power amplifier design of high power fiber lasers, where a single amplifier or chain of amplifiers receive a pulse from the master oscillator, are pumped to store energy, and extract the energy into a useful pulse. Random backscattering causes unwanted laser oscillations in the amplifiers with the release of the energy in the backward direction. Random backscattering causes the signal to reach unsafe power levels, which causes catastrophic optical damage to the fiber components such as fiber pigtailed optical components or gain fiber.

Random backscattering coherence and power dependency has led to interpretations of it as Stimulated Brillouin Scattering (SBS), even though experiments have yet to prove such a link. Instead, random backscattering appears to be caused by SBS, along with other feedback mechanisms, such as backreflections (e.g., end reflections), Rayleigh scattering, seed laser coherence, and random seeded lasing. In master oscillator power amplifier designs, random backscatter imposes a practical limit to the gain, peak power, and maximum energy that can be stored without spontaneous discharge, extracted, and delivered as useful laser power without damage to optical components. To avoid this damage caused by random backscattering, the output peak power and energy must be significantly reduced.

Master oscillator power amplifier designs are also affected by backreflections (e.g., a deterministic backreflected pulse, a Fresnel end reflection, end reflections, etc.), which are pulses reflected back from the termination of an output fiber after the amplifiers, and are not the same as random backscattering, although both can cause unwanted laser oscillations and reduce peak power. Backreflections are typically cured by placing a faraday isolator (e.g., Faraday rotation based optical isolator) or another attenuator between the master oscillator and the power amplifier.

U.S. Pat. No. 4,902,980 to O'Meara, the disclosure of which is herein incorporated by reference in its entirety, is directed to a master oscillator power amplifier high powered laser system with a ring oscillator and attenuator (spatial filter or optical isolator) to prevent backreflected pulses inadvertently fed back into the oscillator causing unwanted oscillation and damage to the oscillator. However, O'Meara falls short, because it does not address random backscattering, a concern separate and apart from backreflected pulses. Further, random backscattering is often less understood and produces larger undesired pulses. Another shortcoming of O'Meara is that optical isolators may add to backreflections, since optical isolators consist of several micro-optical elements, each contributing discrete reflections at their interfaces, even with antireflection coatings. These discrete interface reflections can give Fabry-Perot cavity structure in the discrete reflections such that certain narrow optical wavelength bands have larger than average backreflection.

### SUMMARY OF THE INVENTION

The present invention overcomes these and other deficiencies of the prior art by providing techniques that are effective in suppressing detrimental coherence effects such as random backscatter. In a fiber laser having a master oscillator power amplifier design, inserting a decorrelator in between the master oscillator and a first power amplifier or inserting a decorrelator in between the first power amplifier and a second power amplifier reduces random backscatter and thereby allows for much more energy to be stored and higher gain without the risk of catastrophic optical damage, thus increasing the peak power that can be delivered as useful laser power. Backscattering can be further reduced by having the master oscillator depolarized, injection locked, and spectrally broadened to reduce the coherence length of the master oscillator.

In an embodiment of the invention, a laser device comprises: an oscillator producing a laser signal; a first amplifier in series with the oscillator, the first amplifier comprising an input and an output, the input of the first amplifier receiving the laser signal; and a first decorrelator, the first decorrelator located between the oscillator and the first amplifier, the first decorrelator comprising a first section of polarization maintaining fiber and a second section of polarization maintaining fiber, the first section at an offset angle to the second section to reduce random backscatter from the laser signal.

The first section and the second section of the decorrelator may be spliced together, rotate polarization of the laser signal, include high birefringent optical fibers, and extend the path length between the oscillator and the first amplifier to reduce coherent backreflections. The decorrelator may be longer than a coherence length of the oscillator resulting in depolarization of the laser signal. The device may further comprise dithering the laser signal to reduce coherence length, depolarizing the oscillator to further reduce random backscatter, spectral broadening the oscillator to reduce coherence length of the oscillator to further reduce random backscatter, and broadband injection locking the oscillator to further reduce random backscatter. The device may further comprise a second amplifier in series with the first amplifier, the second amplifier comprising an input and an output, the input of the second amplifier receiving the laser signal. The device may further comprise a second decorrelator, the second decorrelator located between the first amplifier and the second amplifier. The device may further comprise an isolator to reduce backreflections or a wave plate to reduce backscattering. The oscillator may comprise a master oscillator or a seed laser, which may be spectrally broadened by injection locking or dithering. The first amplifier and the second amplifier may comprise power amplifiers or fiber amplifiers.

In another embodiment of the invention, a method comprises the steps of: producing a laser signal; receiving the laser signal with a first decorrelator, the first decorrelator comprising a first section of polarization maintaining fiber and a second section of polarization maintaining fiber, the first section at an offset angle to the second section to reduce degree of polarization of the laser signal; and receiving the laser signal from the first decorrelator with a first amplifier. The method may further comprise a second decorrelator receiving the laser signal from the first amplifier and a second amplifier receiving the laser signal from the second decorrelator. The first section of polarization maintaining fiber and the second section of polarization maintaining fiber may be spliced together.

In another embodiment of the invention, a device comprises a decorrelator, the decorrelator configured to receive a laser signal from a laser, the decorrelator comprising a first section of polarization maintaining fiber and a second section of polarization maintaining fiber, the first section at an offset angle to the second section to reduce random backscatter from the laser signal, and the decorrelator configured to provide the laser signal to an amplifier. The device may further comprise dithering or broadband injection locking to reduce backscattering.

In another embodiment of the invention, a laser device comprises: a master oscillator spectrally broadened by injection locking from an optical circulator coupled to the master oscillator, a first amplifier in series with the master oscillator, the first amplifier comprising an input and an output, the input of the first amplifier receiving the laser signal from the master oscillator.

An advantage of the present invention is that it allows higher amplification gain without component damage, allowing for lasers with greater power and energy output. As higher gain can be extracted per amplifier, the invention allows for lower cost systems since less amplification stages are needed for a given output power. Suppression of coherence effects lead to improved stability of the laser output power. The use of the invention will also result in a reduced degree of polarization of the laser output, which will by itself add value in processes where the otherwise random output polarization gives a varying processing result.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a prior art master oscillator power amplifier design;

FIG. 2 illustrates a master oscillator power amplifier system according to an embodiment of the invention;

FIGS. 3-4 illustrate two views of a decorrelator according to an embodiment of the invention;

FIG. 5 illustrates a master oscillator power amplifier system according to an embodiment of the invention;

FIG. 6 illustrates a master oscillator power amplifier system according to an embodiment of the invention;

FIG. 7 illustrates a master oscillator power amplifier system according to an embodiment of the invention;

FIG. 8 illustrates a master oscillator power amplifier system according to an embodiment of the invention;

FIGS. 9-10 illustrate test results showing the amount of random backscatter when a decorrelator is omitted and when the decorrelator is included in a master oscillator power amplifier system according to an embodiment of the invention; and

FIG. 11 illustrates a process of reducing random backscatter in a laser according to an embodiment of the invention.

### DETAILED DESCRIPTION OF EMBODIMENTS

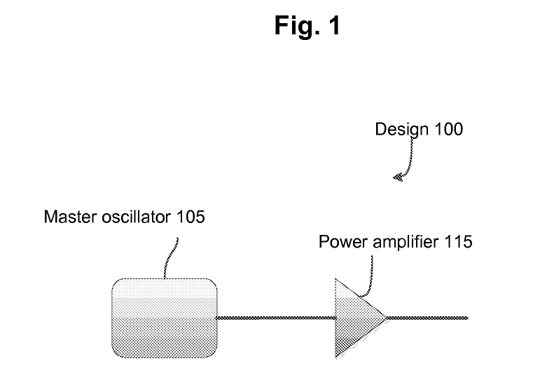

Further features and advantages of the invention, as well as the structure and operation of various embodiments of the invention, are described in detail below with reference to the accompanying FIGS. 1-11, wherein like reference numerals refer to like elements. Although the invention is described in the context of high power fiber laser oscillators, one of ordinary skill in the art can apply these concepts to other laser designs, such as gas lasers, excimer lasers, solid-state lasers, fiber lasers, photonic crystal lasers, semiconductor lasers, glass lasers, and Raman lasers. For the purposes of this present disclosure, coherence effects and random backscattering are used interchangeably, and they may include, but are not limited to: Raman scattering, Stimulated Brillouin Scattering (SBS) or Brillouin Scattering, Rayleigh scattering, spurious/random lasing, backscattering, resonant random backscatter, backscatter effects, resonant backscatter lasing, seeded random lasing, seeded laser coherence, coherent random backscatter effect, multiple pass bouncing, and combinations thereof.

The present invention provides techniques for effectively suppressing detrimental coherence effects such as, but not limited to, random backscatter. In a fiber laser having a master oscillator power amplifier design, inserting a decorrelator in between the master oscillator and a first power amplifier or inserting a decorrelator in between the first power amplifier and a second or subsequent power amplifier reduces random backscatter, which allows for much more energy to be stored and higher gain without the risk of catastrophic optical damage, thus increasing the peak power that can be delivered as useful laser power. Backscattering can be further reduced by having the master oscillator depolarized, injection locked, and spectrally broadened to reduce the coherence length of the master oscillator.

The present invention provides several ways to reduce backscatter. For example, by placing decorrelator elements in the amplifier chain of the master oscillator power amplifier fiber laser, unwanted laser oscillations are suppressed by breaking up polarization. The decorrelator provides nonlinear polarization rotation in-between reflection points, thus breaking polarization self-consistency of oscillation round trip. In another set of ways to reduce backscatter, the master oscillator is depolarized, injection locked, and/or spectrally broadened. By depolarizing, injection locking, and/or nonlinear spectral broadening of the master oscillator forward pulse directly before the signal enters an amplifier with possible random lasing modes from scattering and reflections, this causes less power to be seeded per mode thereby increasing gain thresholds and SBS threshold.

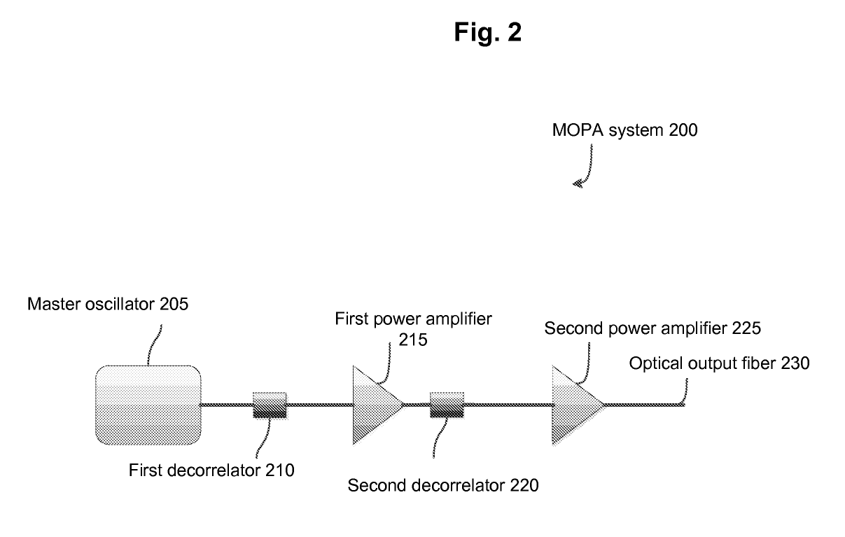

FIG. 2 illustrates a master oscillator power amplifier (MOPA) system 200 according to an embodiment of the invention. The MOPA system 200 comprises a master oscillator 205, a first decorrelator 210, a first power amplifier 215, a second decorrelator 220, a second power amplifier 225, and an optical output fiber 230. The MOPA system 200 produces and amplifies a laser signal, and reduces random backscatter allowing for lasers with higher amplification gain and power without component damage. The MOPA system 200 can be implemented as a high power fiber laser, with a seed laser for producing a laser beam light signal and a laser amplifier for boosting the output power, the implementation of which are apparent to one of ordinary skill in the art. High power fiber lasers can be created from active optical fibers and semiconductor diodes, where single emitter semiconductor diodes are used as the light source to pump the active fibers. The laser beam is contained within the optical fibers and can be delivered through an armored flexible cable, the implementation of which is apparent to one of ordinary skill in the art. The optical fibers allow for an extremely bright light to be emitted from a very small core, such as kilowatt class output with excellent beam quality.

The master oscillator 205 (e.g., master laser, seed laser, solid-state bulk laser, etc.) produces a beam of light to be amplified by the first power amplifier 210 after passing through the first decorrelator 210. The master oscillator 205 may cause random lasing modes in the first amplifier 215 and the second amplifier 225 with multiple reflection points caused from Rayleigh random backscatter, SBS, and backreflections acting cooperatively, affecting phase and polarization. Random backscattering often causes damage to upstream components, such as pump laser diodes and pump signal multiplexers, when the frequency (e.g., pulse repetition frequency) is low and the pump power is high. Random backscattering may have a short duration and high peak power compared to the forward pulse from the master oscillator 205.

The first decorrelator 210 can be an optical fiber device including sections of polarization maintaining high birefringent optical fibers spliced together with an offset angle between the principal axes and placed between in or around the amplifier stages. The first decorrelator 210 can be a polarization maintaining (PM) fiber depolarizer. Decorrelation, in general, reduces autocorrelation within a signal and cross correlation within a set of signals. The inclusion of the first decorrelator 210 before the first power amplifier 215 effectively suppresses random scattering, which allows higher gain to be achieved in the amplifier stages without risk of catastrophic optical damage. Further, the first decorrelator 210 suppresses unwanted laser oscillations which allow for higher energy and peak power from the system 200. This is partly due to both the fiber of the first decorrelator 210 having polarization maintaining (PM) high birefringent and partly due to the fiber of the first decorrelator 210 having two sections, where the sections are spliced together, rotate polarization, and have an offset angle between the sections, each contributing to suppressing unwanted laser oscillations. Additional suppression occurs when the path length is increased between the components causing end reflections. The first decorrelator 210 may be helpful for many non-polarization maintaining (PM) fiber laser products.

The first power amplifier 215 (e.g., an optical amplifier, a laser amplifier, a fiber amplifier as in the master oscillator fiber amplifier design, a bulk amplifier, a semiconductor optical amplifier, etc.) boosts the output power of the light produced by the master oscillator 205 while retaining the light's properties. After the first power amplifier 215 and the second power amplifier 225, the optical output fiber 230 outputs an amplified version of the light produced by the master oscillator 205.

The first decorrelator 210 and second decorrelator 220 can have the same properties, and the first power amplifier 215 and second power amplifier 225 can have the same properties.

Although the system 200 includes two stages of amplifiers, first power amplifier 215 and second power amplifier 225, which are useful for higher power levels, the system 200 would also be functional with a single amplifier stage or more than two stages. Similarly, although the system 200 includes two stages of decorrelators, first decorrelator 210 and second decorrelator 220, which are useful for blocking random backscatter, the system 200 would also be functional with a single decorrelator stage or more than two stages.

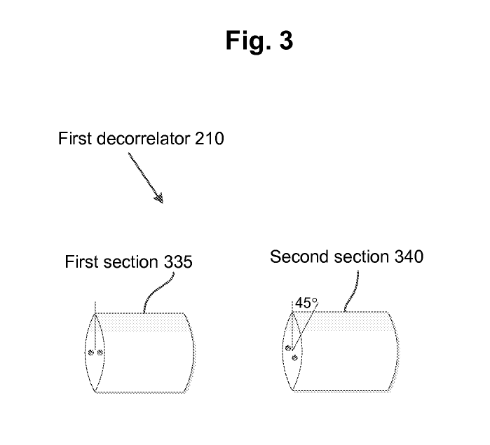

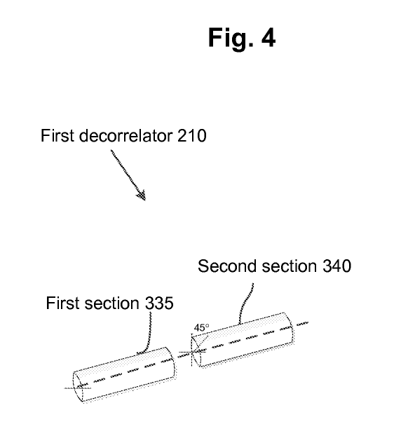

FIGS. 3-4 illustrate two views of the first decorrelator 210 according to an embodiment of the invention. In one embodiment, the first decorrelator 210 is a high birefringent polarization maintaining (PM) optical fiber. Low and high birefringement fibers are terms known in the art. For example, a high birefringent fiber includes fibers that are deliberately made to increase birefringence (e.g., a panda fiber with stress rods on the side of the fiber core, an elliptical core fiber where the core is processed so it is non-circular, etc.). A low birefringent fiber includes fibers which are made to have circular symmetry. Tests have shown that low birefringent fiber, as oppose to PM fiber with high birefringent, has little effect on random backscattering. The second decorrelator 220 may be composed of the same material as the first decorrelator 210. The first decorrelator 210 includes a first section 335 and a second section 340, where the sections 335, 340 are spliced together at an offset angle to each other (e.g., polarized, polarization decorrelation, etc.). In one embodiment, the offset angle is approximately 45 degrees. In another embodiment, the offset angle is an angle other than 45 degrees. Multiple decorrelators can be used in series with power amplifiers for polarization decorrelation in combination with temporal decorrelation. Random backscatter can be further suppressed by nonlinear polarization rotation, and additional path length between end reflections and nonlinear spectral broadening.

In an embodiment of the invention, the random backscatter is reduced by nonlinear spectral broadening of the master oscillator 205. Spectral broadening, also known as deliberate non-linear spectrum broadening, reduces the coherence length of the master oscillator 205, and allows for fewer and shorter decorrelation elements to be used. Spectral broadening can be obtained through fast dithering compared to the pulse signals. Dithering, in general, can be an intentionally applied form of noise used to randomize quantization error. In one embodiment, the dithering speed is a tone greater than 150 MHz on top of a 100 nsec pulse from the master oscillator 205. In another embodiment, a broadband source (e.g., amplified spontaneous emission fiber or superluminescent source) is used for broadband injection locking. Spectral broadening can also be obtained through multiple sections of low birefringent small core fibers. The multiple sections can be used separately, or in combination with, other linear polarization elements.

In one embodiment, the first decorrelator 210 and the second decorrelator 220 use high birefringent polarization maintaining (PM) fiber sections, where the PM fiber sections are of a length comparable to or longer than the length of the master oscillator coherence. Further, the PM fiber sections are fusion spliced together at an offset angle (e.g., approximately 45 degrees) and then fusion spliced to the fiber at the amplifier inputs in the master oscillator power amplifier chain, such as to intercept reflections (e.g., between an input isolator and a gain fiber).

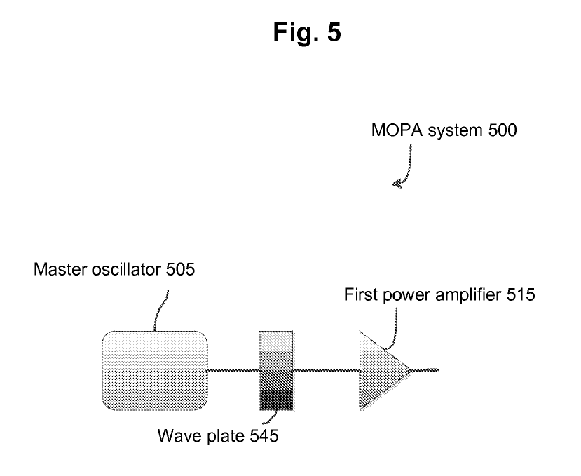

FIG. 5 illustrates a MOPA system 500 according to an embodiment of the invention. The MOPA system 500 includes a master oscillator 505, a wave plate 545, and a first power amplifier 515. The MOPA system 500 provides polarization decorrelation to suppress random backscatter in addition to or as an alternative to polarization maintaining fiber decorrelators. The master oscillator 505 and first power amplifier 515 can have similar or the same qualities as the master oscillator 205 and first power amplifier 215. The wave plate 545 creates depolarization and suppresses random backscatter. In general, a wave plate can be an optical device that alters or rotates the polarization state of a light wave travelling through it, where the wave plate shifts the phase between two perpendicular polarization components of the light wave. The wave plate 545 can be a bulk optical wave plate. In another embodiment, the system 500 includes a nonlinear polarization crystal instead of or in addition to the wave plate 545.

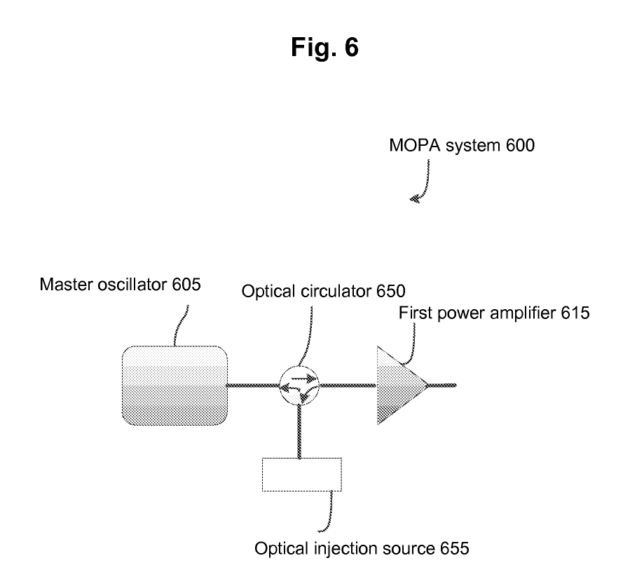

FIG. 6 illustrates a MOPA system 600 according to an embodiment of the invention. The MOPA system 600 comprises a master oscillator 605, an optical circulator 650, a first power amplifier 615, and an optical injection source 655. The MOPA system 600 provides an additional way to suppress random backscatter, by broadband injection locking of the master oscillator 605. The master oscillator 605 and first power amplifier 615 can have similar or the same qualities as the master oscillator 205 and first power amplifier 215. The optical injection source 655 can be a broadband optical injection signal coupled in the backward direction with the optical circulator 650 or another optical coupler to lock the spectrum of the light from the master oscillator 605 (e.g., seed laser). This broadband injection locks the master oscillator and reduces coherence and random backscatter.

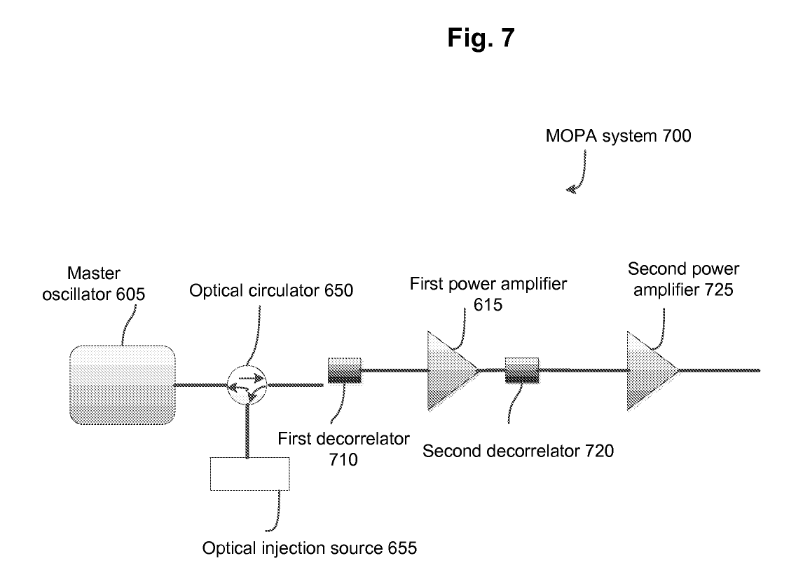

FIG. 7 illustrates a MOPA system 700 according to an embodiment of the invention. The MOPA system 700 comprises the master oscillator 605, the optical circulator 650, a first decorrelator 710, the first power amplifier 615, a second decorrelator 720, a second power amplifier 725, and the optical injection source 655. FIG. 7 illustrates that the optical injection source 655 can also be used in combination with decorrelators to further reduce random backscatter.

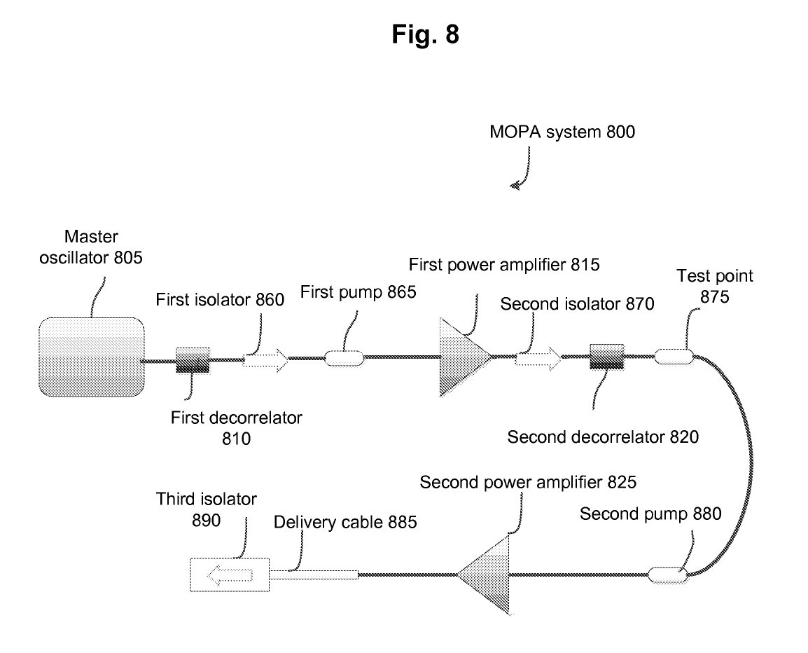

FIG. 8 illustrates a MOPA system 800 according to an embodiment of the invention. The MOPA system 800 comprises a master oscillator 805, a first decorrelator 810, a first isolator 860, a first pump 865, a first power amplifier 815, a second isolator 870, a second decorrelator 820, a test point 875, a second pump 880, a second amplifier 825, a delivery cable 885, and a third isolator 890. The MOPA system 800 shows optical design components that may be used, including isolators 860, 870, and 890, along with decorrelators 810, 820, to suppress both backreflections and random backscattering.

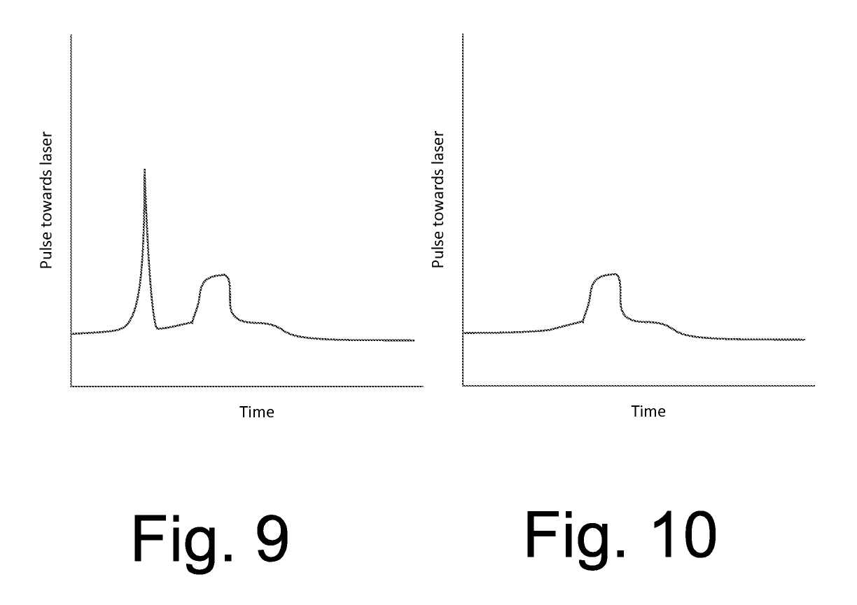

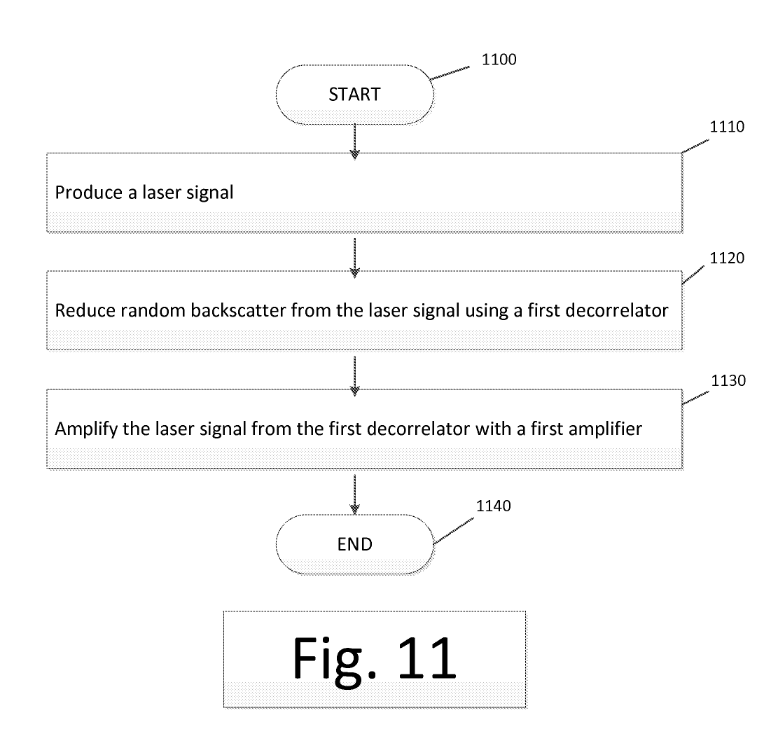

FIGS. 9-10 illustrate test results showing the amount of random backscatter when a decorrelator is omitted (FIG. 9) and when the decorrelator is included (FIG. 10) in a master oscillator power amplifier system according to an embodiment of the invention. For this test, a set-up was devised to measure backscatter in the master oscillator power amplifier system with two power amplifier stages supplied with light from a master oscillator. The backscatter was monitored at the input of the second amplifier by using a fiber optical tap test point.

FIG. 9 illustrates test results without a decorrelator. The pulse is fed back into the laser over time with a pulse repetition frequency (PRF) set at 50 kHz, and a test pulse width of 120 nsec with constant average output power. The PRF was lowered from 100 kHz to 50 kHz, and at 50 kHz random backscatter was observed great enough to damage components. The signal has a random backscatter pulse spike followed by a small backreflected pulse spike. The backreflected pulse spike can be a pulse reflected back from the termination of an output fiber located at the output of the second amplifier stage. The random backscatter pulse spike is shown to be larger in amplitude and shorter in duration than the backreflected pulse spike. As such, operation in the presence of random backscatter is likely to cause catastrophically optical damage to upstream components due to amplification and very high peak power. Since catastrophic damage can occur at 50 kHz, frequencies below 50 kHz did not need to be tested. At 50 kHz, without a decorrelator, the peak output power is 10 kW and the peak gain is 25 dB.

FIG. 10 illustrates the pulse fed back into the laser over time with a decorrelator prior to each amplifier in the master oscillator power amplifier system, with the same operating parameters as FIG. 9, including a frequency at 50 kHz. As shown, including a decorrelator produces unexpected results, in that the random backscattered is eliminated, although the backreflected pulse peak is unchanged. To eliminate the backreflected pulses, an attenuator such as a faraday isolator can be used. Embodiments of the present invention are used along with a faraday isolator to further increase the power, gain, and energy thresholds to even higher levels. The frequency was lowered to 36.5 kHz, where the peak output power is 20 kW and the peak gain is 27.6 dB without random backscatter or risk of component damage. Thus, the addition of decorrelators doubles the output power and increases the gain without risk of component damage.

Even with the fundamental cause for random backscatter not being fully understood, FIGS. 9-10 clearly illustrate that use of a decorrelator effectively suppresses random backscatter to obtain larger peak power. Tests conducted using a low birefringent fiber, as oppose to a decorrelator, were ineffective at blocking random backscatter, even though the length and mode field diameter were the same. The use of decorrelators in fiber lasers significantly increases the attainable peak powers and gain per amplifier stage. Decorrelators having high birefringent fibers spliced with an offset angle and placed between master oscillator power amplifier stages suppress random backscatter. Tests have shown that adding decorrelators to the system increases the peak power rating of the system from 12 kW to 18 kW, a 50% improvement. Embodiments of the invention increase the threshold for unwanted discharge of the stored energy, and thus allow increased stored energy and gain in pulsed master oscillator power amplifier fiber lasers.

FIG. 11 illustrates a process of reducing random backscatter in a laser according to an embodiment of the invention. The process starts at step 1100. At step 1110, the master oscillator 205 produces a laser signal. Then, at step 1120, the first decorrelator 210 reduces random backscatter. Next, the first amplifier 215 amplifies the laser signal from the first decorrelator 210 at step 1130. The process may be repeated recursively a number of times and ends at step 1140.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A laser device comprising:
an oscillator producing a laser signal;
a first amplifier in series with the oscillator, the first amplifier comprising an input and an output, the input of the first amplifier receiving the laser signal; and
a first decorrelator, the first decorrelator located between the oscillator and the first amplifier, the first decorrelator comprising a first section of polarization maintaining fiber and a second section of polarization maintaining fiber, the first section at an offset angle to the second section to reduce random backscatter from the laser signal.

2. The device of claim 1, wherein the first section and the second section of the decorrelator are spliced together.

3. The device of claim 1, wherein the first section and the second section of the decorrelator rotate polarization of the laser signal.

4. The device of claim 1, wherein the first section and the second section of the decorrelator comprise high birefringent optical fibers.

5. The device of claim 1, wherein the first section and the second section of the decorrelator extend the path length between the oscillator and the first amplifier to reduce coherent backreflections.

6. The device of claim 1, wherein the decorrelator is longer than a coherence length of the oscillator resulting in depolarization of the laser signal.

7. The device of claim 1, further comprising dithering the laser signal to reduce coherence length.

8. The device of claim 1, further comprising depolarizing the oscillator to further reduce random backscatter.

9. The device of claim 1, further comprising spectral broadening the oscillator to reduce coherence length of the oscillator to further reduce random backscatter.

10. The device of claim 1, further comprising broadband injection locking the oscillator to further reduce random backscatter.

11. The device of claim 1, further comprising a second amplifier in series with the first amplifier, the second amplifier comprising an input and an output, the input of the second amplifier receiving the laser signal.

12. The device of claim 11, further comprising a second decorrelator, the second decorrelator located between the first amplifier and the second amplifier.

13. The device of claim 1, further comprising an isolator to reduce backreflections.

14. The device of claim 1, further comprising a wave plate to reduce backscattering.

15. The device of claim 1, wherein the oscillator comprises a master oscillator or seed laser.

16. The device of claim 15, wherein the master oscillator or seed laser is spectrally broadened by injection locking or dithering.

17. The device of claim 1, wherein the first amplifier and the second amplifier comprise power amplifiers or fiber amplifiers.

18. A method comprising:
producing a laser signal;
receiving the laser signal with a first decorrelator, the first decorrelator comprising a first section of polarization maintaining fiber and a second section of polarization maintaining fiber, the first section at an offset angle to the second section to reduce degree of polarization of the laser signal; and
receiving the laser signal from the first decorrelator with a first amplifier.

19. The method of claim 18, further comprising a second decorrelator receiving the laser signal from the first amplifier.

20. The method of claim 19, further comprising a second amplifier receiving the laser signal from the second decorrelator.

21. The method of claim 18, wherein the first section of polarization maintaining fiber and the second section of polarization maintaining fiber are spliced together.

22. A device comprising a decorrelator, the decorrelator configured to receive a laser signal from a laser, the decorrelator comprising a first section of polarization maintaining fiber and a second section of polarization maintaining fiber, the first section at an offset angle to the second section to reduce random backscatter from the laser signal, and the decorrelator configured to provide the laser signal to an amplifier.

23. The device of claim 22, further comprising dithering or broadband injection locking to reduce backscattering.

24. A laser device comprising: a master oscillator spectrally broadened by injection locking, a broad band injection locking source optically coupled to the master oscillator, a first amplifier in series with the master oscillator, the first amplifier comprising an input and an output, the input of the first amplifier receiving the laser signal from the master oscillator.
